(19) United States
(12) Patent Application Publication
(10) Pub. No.: US 2025/0092949 A1
(43) Pub. Date: Mar. 20, 2025

(54) RECIPROCATING PLUNGER PUMP WITH BI-DIRECTIONAL MULTI-COMPONENT CRANKCASE SEAL

(71) Applicant: A.W. CHESTERTON COMPANY, Groveland, MA (US)

(72) Inventors: Thomas RICHARD, Middleton, MA (US); Michael POLANSKY, Magnolia, TX (US)

(21) Appl. No.: 18/889,615

(22) Filed: Sep. 19, 2024

Related U.S. Application Data
(60) Provisional application No. 63/583,721, filed on Sep. 19, 2023.

(51) Int. Cl. F16J 15/3204; F04B 19/22

(52) U.S. Cl. CPC F16J 15/3204; F04B 19/22

(57) ABSTRACT

A bi-directional sealing assembly for providing a fluid seal for a pony rod in stationary equipment. The sealing assembly can include first and second sealing assemblies and an intermediate mechanical component. The sealing subassemblies can include a flange element configured for contacting the pony rod. The flange elements contact and form a bi-directional fluid seal with the pony rod when mounted thereabout, such that the first sealing subassembly forms a first fluid seal when the pony rod moves in a first axial direction and the second sealing subassembly forms a second fluid seal when the pony rod moves in a second axial direction opposite to the first axial direction.

### RELATED APPLICATION

The present application claims priority to U.S. provisional patent application Ser. No. 63/583,721, filed on Sep. 19, 2023, and entitled Reciprocating Plunger Pump With Bi-Directional Multi-Component Crankcase Seal, the contents of which are herein incorporated by reference.

### BACKGROUND OF THE INVENTION

Conventional plunger pumps are often used in various industrial applications to transfer fluids from one location to another and are commonly employed in processes where high-pressure fluids are required, such as in hydraulic systems, water jet cutting, food process (i.e. homogenization), and industrial cleaning. The plunger pumps generate high-pressure fluid flow by using the reciprocating motion of a piston or plunger. The plunger is situated within a pump housing. The plunger pump can also include a pony rod that is coupled to a plunger element at one end and to a connecting rod at an opposed end.

The conventional plunger pumps typically require efficient sealing mechanisms to prevent fluid leakage from the pump crankcase and to maintain the integrity of the crankcase. The conventional sealing mechanisms can include a pony rod seal. The pony rod seal helps maintain the separation between the atmosphere and the lower-pressure crankcase chamber, preventing contaminants and other fluids from entering the crankcase chamber and potentially causing contamination or other operational issues. The pony rod seals are typically made of durable, wear-resistant materials, such as rubber or polyurethane, and are suitable for withstanding the harsh conditions within the pump's crankcase. The conventional pony rod seals are designed as a simple ring or collar that fits around the pony rod, which is connected to the reciprocating plunger. The pony rod seal is usually installed in a gland or housing to ensure proper sealing. The pony rod seal creates a unidirectional barrier seal between the high-pressure fluid environment within the pumping chamber and external or atmospheric pressure and the crankcase chamber. The unidirectional seal prevents the leakage of fluids, including the pumping liquid and lubricating oil, from escaping into the surrounding environment. The pony rod seals can also help reduce friction between the pony rod and the associated seal in order to minimize wear and heat generation, thereby prolonging the seal's lifespan and maintaining pump efficiency.

### SUMMARY OF THE INVENTION

The present invention is directed to a bi-directional sealing assembly that helps prevent fluid from entering the crankcase and the fluid in a crankcase from escaping. The bi-directional sealing assembly thus helps prevent contamination or other operational issues. The bi-directional sealing assembly can include separate sealing subassemblies that are configured and oriented to form a seal with a pony rod when the rod moves in a selected direction.

The present invention is directed to a bi-directional sealing assembly for providing a fluid seal for a pony rod in stationary equipment. The sealing assembly can include first and second sealing assemblies and an intermediate mechanical component. The first sealing subassembly has a first primary sealing element having a main body that has a top surface, an opposed bottom surface, and a side surface having a first side channel formed therein, and a first biasing element sized and configured for seating in the first side channel. The second sealing subassembly has a second primary sealing element having a main body that has a top surface, an opposed bottom surface, and a side surface having a second side channel formed therein, and a second biasing element sized and configured for seating in the second side channel. The intermediate mechanical component is disposed between the first sealing subassembly and the second sealing subassembly to help position the first and second sealing subassemblies relative to each other.

The first sealing subassembly, the second sealing subassembly, and the intermediate mechanical component are configured to be axially spaced and aligned and concentrically disposed about the pony rod when mounted thereabout. The intermediate mechanical component can optionally directly contact both the first sealing subassembly and the second sealing subassembly.

Specifically, the first primary sealing element has a second side surface opposite the side surface with the first side channel and the second primary sealing element has a second side surface opposite the side surface with the second side channel, and the intermediate mechanical component contacts the second side surface of each of the first primary sealing element and the second primary sealing element.

The top surface of the first primary sealing element has a first top channel formed therein, and the first sealing subassembly further includes a first sealing element sized and configured for seating in the first top channel. The top surface of the second primary sealing element has a second top channel formed therein and the second sealing subassembly further includes a second sealing element sized and configured for seating in the second top channel. Further, the bottom surface of the first primary sealing element has a first flange portion and the bottom surface of the second primary sealing element has a second flange portion.

The first biasing element when mounted in the first side channel biases the first flange portion outwardly from the bottom surface of the first primary sealing element, and the second biasing element when mounted in the second side channel biases the second flange portion outwardly from the bottom surface of the second primary sealing element. The first and second flange portions are configured to contact and form a bi-directional fluid seal with the pony rod when mounted thereabout. According to one embodiment, the first flange portion extends axially outwardly from the bottom surface of the first primary sealing element in a first axial direction and the second flange portion extends axially outwardly from the bottom surface of the second primary sealing element in a second axial direction opposite to the first axial direction. The first sealing subassembly forms a first fluid seal when the pony rod moves in a first axial direction, and the second sealing subassembly forms a second fluid seal when the pony rod moves in a second axial direction opposite to the first axial direction.

The seal assembly can further include one or more optional spacer elements for axially spacing the first sealing subassembly, the second sealing subassembly, and the intermediate mechanical component along the pony rod, and a retention element for retaining together the first sealing subassembly, the second sealing subassembly, and the intermediate mechanical component. The retention element can be a snap ring, and the intermediate mechanical component can be a lantern ring. The lantern ring can include a plurality of fluid openings for allowing passage of a fluid therethrough. Further, each of the first and second biasing elements can include a spring.

### BRIEF DESCRIPTION OF THE DRAWINGS

These and other features and advantages of the present invention will be more fully understood by reference to the following detailed description in conjunction with the attached drawings in which like reference numerals refer to like elements through the different views. The drawings illustrate principals of the invention and, although not to scale, show relative dimensions.

FIG. 1 is a schematic diagram showing the primary elements of a plunger pump that employs a bi-directional sealing assembly according to the teachings of the present invention.

FIG. 2 is an exploded unassembled view of the bi-directional sealing assembly according to the teachings of the present invention.

FIG. 3 is an exploded unassembled cross-sectional view of the bi-directional sealing assembly of FIG. 2 according to the teachings of the present invention.

FIG. 4 is a partial exploded unassembled cross-sectional view of the bi-directional sealing assembly according to the teachings of the present invention.

FIG. 5 is a partial schematic cross-sectional view of the bi-directional sealing assembly mounted within the plunger pump according to the teachings of the present invention.

FIG. 6 is a partial cross-sectional view of a sealing subassembly of the bi-directional sealing assembly of the present invention.

### DETAILED DESCRIPTION

The terms “mechanical seal assembly,” “seal assembly,” and “seal” as used herein are intended to include various types of fluid sealing systems, including single or solid seals, split seals, concentric seals, spiral seals, cartridge seals, and other known seal and sealing types and configurations.

The terms “stationary equipment,” “stuffing box” and/or “static surface” as used herein are intended to include any suitable stationary structure housing a shaft to which a seal or packing loading assembly having an optional gland or other structure is secured. The stationary structure can include any type of commercial or industrial equipment such as pumps (e.g., a plunger pump), valves, and the like. Those of ordinary skill in the relevant art will readily recognize that the gland can form part of the mechanical seal, packing loading assembly, or the stationary equipment.

The term “sealing assembly” is intended to refer to a combination of components that can be mounted in or coupled to stationary equipment, and the components can be sized and configured to form a secure and effective seal with the shaft associated with the stationary equipment. The sealing assembly can include multiple sealing components forming a sealing element assembly that is mounted or coupled to an optional gland element. The sealing components depend upon the type of sealing assembly employed. For example, in a cap seal, the sealing components can include an energizer element and a sealing or cap element. The sealing assembly can also include a packing assembly having a series of individual packing elements. The packing elements can be optionally braided packing elements formed from suitable packing material.

The term “shaft” is intended to refer to any suitable device in a mechanical system to which a mechanical seal can be mounted and includes shafts, rods, plungers, pistons, and other known devices. The shafts can move in any selected direction, such as for example in a rotary direction or in a reciprocating direction. According to a preferred embodiment, the shaft moves in a reciprocating direction.

The term “gland” or “gland element” as used herein is intended to include any suitable structure that enables, facilitates, or assists securing the mechanical seal or the sealing assembly to the stationary equipment, while concomitantly surrounding or housing, at least partially, one or more sealing components. If desired, the gland can also provide fluid access to the mechanical seal.

The terms “axial” and “axially” as used herein refer to a direction generally parallel to the axis of the shaft. The terms “radial” and “radially” as used herein refer to a direction generally perpendicular to the axis of the shaft. The terms “fluid” and “fluids” refer to liquids, gases, and combinations thereof.

The term “axially inner” or “axially inboard” as used herein refers to that portion of the stationary equipment and/or components of a mechanical seal that are disposed proximate to the stationary equipment (e.g., mechanical system) employing the mechanical seal. As such, this term also refers to the components of the mechanical seal or packing loading assembly that are mounted to or within the stationary equipment or are disposed the deepest within or closest to the equipment (e.g., inboard). Conversely, the term “axially outer” or “axially outboard” as used herein refers to the portion of stationary equipment and the mechanical seal or packing loading assembly that is disposed distal (e.g., outboard) from the equipment.

The term “radially inner” as used herein refers to the portion of the mechanical seal, packing loading assembly or associated components that are proximate to a shaft. Conversely, the term “radially outer” as used herein refers to the portion of the mechanical seal, packing loading assembly or associated components that are distal from the shaft.

The terms “inboard” and “outboard” as used herein in relation to a mechanical seal and/or stationary equipment refers to an axial position of components forming part of the mechanical seal or fluid regulating system relative to the equipment being sealed. The inboard position of the components typically refers to a position within the stationary equipment on the side of the seal closest to the fluid being sealed. The inboard components can be designed to prevent the process fluid from leaking out of the stationary equipment and into the environment or other parts of the equipment or system. In contrast, an outboard seal is positioned outside the stationary equipment on the side of the seal farthest from the process fluid and axially spaced from the inboard seal. The outboard seal is typically used in tandem with the inboard seal in double seal configurations to provide additional containment and protection.

The terms “process medium” and/or “process fluid” as used herein generally refer to the medium or fluid being transferred through the stationary equipment. In pump applications, for example, the process medium is the fluid being pumped through the pump housing.

The term “ambient environment” or “ambient pressure” is intended to include any external environment or pressure other than the internal environment of the stationary equipment, mechanical seal, gland, and the like.

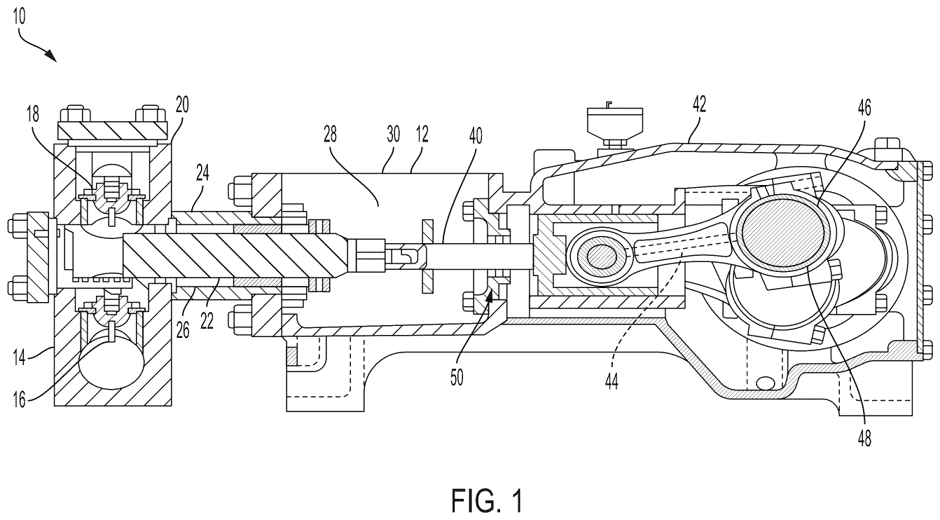

FIG. 1 is a schematic cross-sectional representation of a plunger pump that can employ a bi-directional sealing assembly according to the teachings of the present invention. The plunger pump can be configured similar to a conventional plunger pump, except for the use of the bi-directional sealing assembly of the present invention rather than the conventional use of a unidirectional sealing device. The plunger pump can be a positive displacement pump where a cylindrical plunger moves back and forth within a chamber, pushing fluid through the pump. The movement of the plunger can cause a selected volume of a fluid to be displaced, generating pressure to move the fluid through pipes or hoses connected to the pump. The plunger pump is commonly used for high-pressure applications in industries such as oil and gas, wastewater treatment, food processing, and chemical processing.

The illustrated plunger pump 10 includes stationary equipment that includes a stationary housing 12 that has, on an intake or input end, a valve section 14. The illustrated valve section 14 can include a suction valve 16 for sucking or pulling in a fluid from a fluid source and a discharge valve 18 for discharging the fluid. More specifically, the suction valve 16 allows fluid to enter a pump chamber 28 formed in a plunger well portion 30 of the housing 12 when a plunger 22 retracts within the housing 12. The plunger 22 can reciprocate through a stuffing box 24 portion of the housing 12 that includes a series of packing elements 26 to form a fluid seal between the plunger 22 and the stuffing box 24. When the plunger 22 moves back or retracts (e.g., an intake stroke), the pressure inside the pump chamber 28 drops below a pressure of the fluid in a supply line of the fluid source. The pressure difference causes the suction valve 16 to open, allowing the fluid from the fluid source to flow into the pump chamber 28. When the plunger moves forward to pressurize the fluid (e.g., discharge stroke), the suction valve 16 closes, preventing backflow of fluid into the supply line. The discharge valve 18 allows the fluid to exit the pump and prevents the fluid from returning to the pump chamber 28. As the plunger 22 moves forward during the discharge stroke, the plunger compresses the fluid inside the pump chamber 28, increasing the pressure. Once the pressure inside the pump chamber 28 exceeds the pressure in the discharge line, the discharge valve 18 opens, allowing the fluid to flow out of the pump 10. When the plunger 22 retracts again, the discharge valve 18 closes, preventing the fluid from re-entering the pump chamber 28.

The illustrated plunger well portion 30 of the plunger pump 10 is the section where the plunger 22 has room to move and operate and to create the pressure necessary to pump the fluid. The plunger 22 can reciprocate within the pump chamber 28 to create the pressure changes necessary to pump the fluid. During the intake stroke, the plunger 22 pulls back, increasing the volume of the pump chamber 28 and creating a vacuum area that causes the suction valve 16 to open, allowing fluid to flow into the pump chamber 28. During the discharge stroke, the plunger 22 moves forward, decreasing the volume of the pump chamber 28 and compressing the fluid, thus increasing the fluid pressure, which forces the discharge valve 18 to open, pushing the fluid out. The packing elements 26 in the stuffing box 24 disposed around the plunger 22 prevent fluid in the pump chamber 28 from leaking therefrom and helps maintain pressure within the pump chamber 28.

The illustrated plunger pump 10 also includes a pony rod 40 that connects the plunger 22 to a power source 46 via a connecting rod 44 that is in turn connected to a crankshaft 48 housed within a crankshaft housing portion 42 of the housing 12. Specifically, the pony rod 40 is coupled to the plunger 22 at one end and to the connecting rod 46 at the other end. The connecting rod 44 is a mechanical linkage that connects the plunger 22 to the crankshaft 48 or eccentric drive mechanism via the pony rod 40. The connecting rod 44 transforms the reciprocating motion of the crankshaft into rotary motion, which is necessary for the operation of the pump 10 by allowing the plunger 22 to move reciprocally, which in turn powers the fluid displacement process. The pony rod 40 ensures that the reciprocating motion generated by the crankshaft 44 is transmitted to the plunger 22. The connecting rod 44 moves the pony rod 40, which in turn moves the plunger 22, in a reciprocating motion. The pony rod 40 transmits the mechanical energy needed for the plunger 22 to create the pressure within the pump chamber 28 in order to pump the fluid. The pony rod 40 can be coupled to the plunger 22 and to the connecting rod 44 through known mechanical connections. The connecting rod 44 converts the rotary motion from the power source 46, such as a motor, into the reciprocating motion that drives the plunger 22. The connecting rod 44 is located in a drive end or crankshaft portion of the plunger pump 10.

The illustrated pony rod 40 passes through a bi-directional sealing assembly 50 of the present invention. The bi-directional sealing assembly helps prevent fluid from leaking or passing from the pump chamber 28 into the crankshaft housing portion during movement of the pony rod 40 in either the intake stroke or the discharge stroke. This helps maintain pressure within the pump housing 28 and helps maintain separation between the high-pressure pumping chamber 28 and the lower-pressure crankcase. The bi-directional sealing assembly 50 is configured to be concentrically disposed about the plunger 22, which functions as a reciprocating shaft, and to help prevent fluid in the pump chamber 28 from passing into the crankshaft housing portion 42 and vice versa. The bi-directional sealing assembly 50 thus helps prevent fluid leakage around the pony rod 40 as the rod reciprocates in the pump chamber 28. In conventional plunger pumps, the pony rod mates with a unidirectional sealing assembly, that is, the sealing assembly is most effective at preventing fluid leakage in one direction—towards the outside of the pump chamber. The sealing assembly seals against high pressure inside the pump chamber, ensuring that fluid does not escape along the pony rod during the plunger's return stroke. The unidirectional capability means that the sealing assembly provides resistance primarily when the internal pump pressure is higher than the external pressure (i.e., preventing outward fluid flow). Conventional unidirectional sealing assembly designs relies on a precise fit between the pony rod and the sealing elements to form the seal.

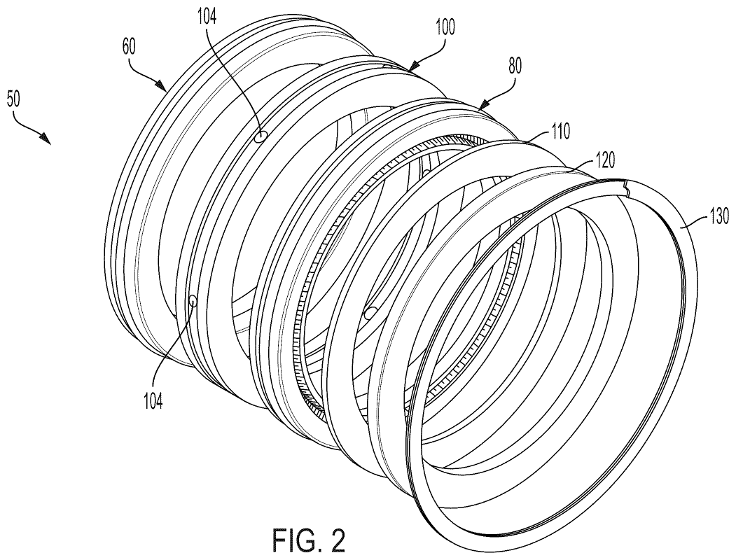

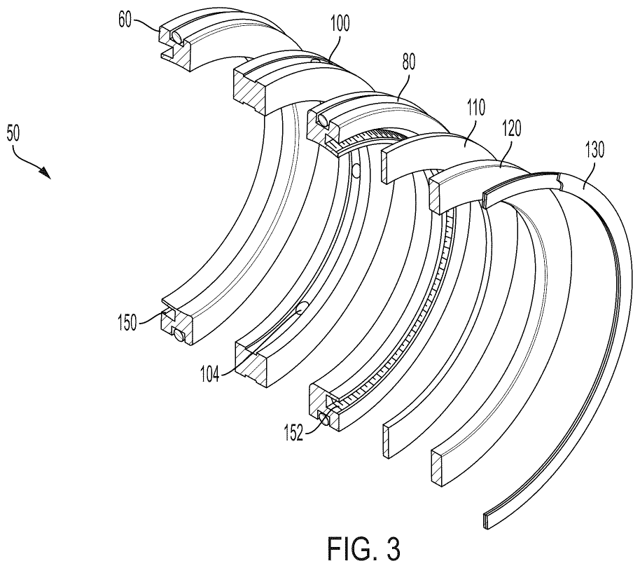

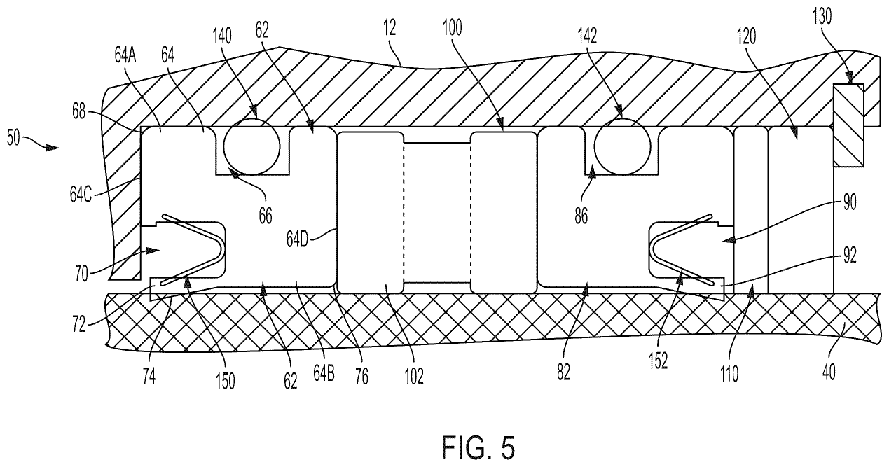

The bi-directional sealing assembly 50 of the present invention is shown for example in FIGS. 2-6. The illustrated bi-directional sealing assembly 50 includes an axial assemblage of components including a first sealing subassembly 60, an intermediate mechanical component 100, a second sealing subassembly 80, optional spacer elements 110, 120, and an optional positioning and retention element 130. The first sealing subassembly 60 forms a seal that helps seal the pony rod 40 when moving during the intake stroke and the second sealing subassembly 80 helps seal the pony rod during the discharge stroke. The use of separate sealing subassemblies helps ensure proper and consistent sealing of the pony rod 40 during each reciprocating stroke. The intermediate mechanical component 100 helps position the first and second sealing subassemblies relative to each other. According to one embodiment, the intermediate mechanical component 100 can be a lantern ring. The lantern ring can be configured to help introduce a cooling or lubricating fluid, such as water or oil, to the bi-directional sealing assembly 50 and to the pony rod 40. The introduced fluid provides lubrication to reduce friction between the bi-directional sealing assembly 50 and the pony rod 40 (e.g., shaft) and helps cool and prevent overheating of the bi-directional sealing assembly 50. The fluid introduced through the lantern ring 100 can also serve to flush away debris or contaminants that may have entered the pump. This prevents abrasive particles from damaging the seals and shaft, ensuring smoother operation. In some cases, the lantern ring helps control or reduce leaks. The fluid pressure injected through the lantern ring can balance the process fluid pressure, reducing the likelihood of leakage past the packing. The spacer elements 110, 120 help space the first and second sealing subassemblies 60, 80 and the intermediate mechanical component 100 along the shaft. The retention element 130, which can be a snap ring, helps position and secure or retain the components of the bi-directional sealing assembly 50 in place along the pony rod 40. The retention element 130 can also serve to compress the bi-directional sealing assembly 50 within the housing 12. The bi-directional sealing assembly 50 can be mounted in the housing portion 12 that corresponds to the transition between the fluid side of the pump and the crankshaft side of the pump. The housing portion 12 can be in the form of a gland or stuffing box. The first sealing subassembly, the second sealing subassembly, and the intermediate mechanical component are configured to be axially stacked and aligned and concentrically disposed about the pony rod 40 in use and when mounted thereabout.

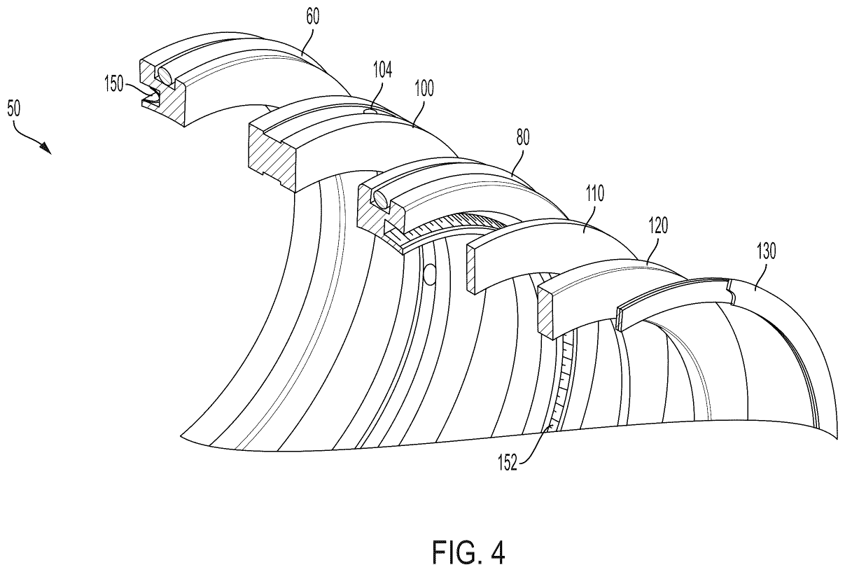

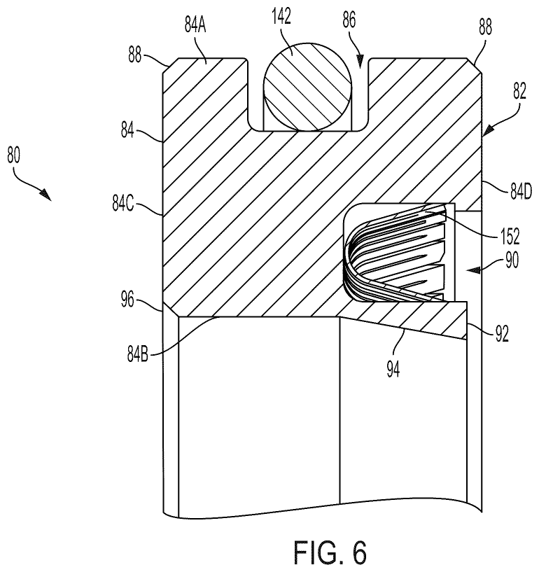

According to one embodiment, the first sealing subassembly 60 and the second sealing subassembly are essentially the same but are disposed in a reverse orientation relative to each other. Specifically, the first sealing subassembly and the second sealing subassembly can include the same number and types of components. Alternatively, the first sealing subassembly and the second sealing subassembly can have a different number of components relative to each other. For the sake of simplicity, we initially describe herein the second sealing subassembly 80 since the first sealing subassembly 60 has similar components. With reference to FIGS. 4-6, and with particular reference to FIG. 6, the second sealing subassembly 80 includes a primary sealing element 82 that has a main body 84. The main body 84 has, relative to an orientation in use, a top surface 84A and an opposed bottom surface 84B, and opposed side surfaces 84C and 84D. The top surface 84A of the main body 84 has a top groove or channel 86 formed therein that is sized and configured for seating a secondary sealing element 142, such as an O-ring. The secondary sealing element 142 forms a seal between the housing 12 and the primary sealing element 82. The top surface 84A can also include an optional pair of chamfered edges 88. The chamfered edges 88 allow for ease of installation of the sealing element into the bore of the stationary equipment 12. The side wall or surface 84D of the main body 82 can also have a side channel or groove 90 formed therein. The side channel 90 can be sized and configured for seating a biasing element 152. The biasing element 152 helps bias the primary sealing element 82 into sealing contact with the pony rod 40. The bottom surface 84B of the main body 82 can have a flange or extension portion 92 that extends axially outwardly from the bottom surface 84B. The flange 92 is biased into sealing contact with the pony rod 40 by the biasing element 152. The flange portion 92 forms a sloped or canted surface 94 relative to the bottom surface 84B. The main body 82 can also have an optional chamfered edge 96 formed in the bottom surface 84D. The chamfered edge 96 allows for ease of installation of the sealing element over the pony rod 40. The illustrated biasing element 152 can have any selected shape provided that the biasing element 152 biases the flange portion 92 into sealing contact with the pony rod 40. According to one embodiment, the biasing element 152 can be a spring element having a relatively or generally U-shaped design.

Similarly, the first sealing subassembly 60 can include a primary sealing element 62 that has a main body 64. The main body 84 has, relative to an orientation in use, a top surface 64A and an opposed bottom surface 64B, and opposed side surfaces 64C and 64D. The top surface 64A of the main body 64 has a top groove or channel 66 formed therein that is sized and configured for seating a secondary sealing element 140, such as an O-ring. The secondary sealing element 140 forms a seal between the housing 12 and the primary sealing element 62. The top surface 64A also includes an optional pair of chamfered edges 68. The side wall or surface 64C of the main body 62 can also have a side channel or groove 70 formed therein. The side channel 70 can be sized and configured for seating a biasing element 150. The biasing element 150 helps bias the primary sealing element 62 into sealing contact with the pony rod 40. The bottom surface 64B of the main body 62 can have a flange or extension portion 72 that extends axially outwardly from the bottom surface 64B. The flange 72 is biased into sealing contact with the pony rod 40 by the biasing element 150. The flange portion 72 forms a sloped or canted surface 74 relative to the bottom surface 64B. The main body 64 can also have an optional chamfered edge 76 formed in the bottom surface 64D. The illustrated biasing element 150 can have any selected shape provided that the biasing element biases the flange portion 72 into sealing contact with the pony rod 40. According to one embodiment, the biasing element 150 be a spring element having a relatively or generally U-shaped design or configuration.

The illustrated bi-directional sealing assembly 50 also includes the intermediate mechanical component 100, such as the illustrated lantern ring. The lantern ring 100 can have a main body 102 that is sized and configured for seating adjacent to the sealing subassemblies 60, 80 when stacked together and concentrically disposed about the pony rod 40. The main body 102 of the lantern ring 100 can be shaped as an annulus having a plurality of fluid openings 104 formed therein. The fluid openings 104 allow for a cooling or lubricating fluid to pass through the main body 102 and contact the primary sealing elements 62, 82 and the pony rod 40. The lantern ring 100 thus enables the pony rod 40 to be lubricated as part of the overall sealing function of the bi-directional sealing assembly 50.

The specific materials and design of the primary sealing elements 62, 82 are selected to withstand the specific conditions present in the crankcase and pump housing of the plunger pump 10, which can include potential exposure to lubricating oil, varying pressures and temperatures, and potential contaminants. The primary sealing elements 62, 82 are thus configured to provide an effective fluid barrier against fluid leakage. Proper lubrication and cooling mechanisms can contribute to the seal's durability and performance by reducing friction, wear, and heat buildup. The lantern ring 100 can be used to provide a cooling or flushing fluid to the sealing subsystem. The primary sealing members can be made from polytetrafluoroethylene (PTFE) compounds which can include PTFE with fillers of carbon, graphite, glass fiber, glass beads, or polyimide. The primary sealing members can also be made of engineered plastics, including polyether ether ketone (PEEK), ultrahigh molecular weight polyethylene, and the like.

The illustrated bi-directional sealing assembly 50 can also include one or more optional spacer elements. According to one embodiment, the bi-directional sealing assembly 50 includes a pair of spacer elements 110, 120. The illustrated spacer elements 110, 120 can have the same size and dimensions or can be differently configured. The spacer elements 110, 120 help maintain the correct alignment, spacing, and performance of the primary sealing elements 62, 82 of the sealing subassemblies 60, 80, respectively. The spacer elements 110, 120 also help distribute the mechanical load and fluid pressure evenly across the entire bi-directional sealing assembly 50. This reduces the risk of excessive wear or failure in any one part of the sealing assembly, ensuring a longer life for the assembly and consistent performance of the pump. Further, by controlling the spacing, the spacer elements 110, 120 help prevent the seals or packing material from being over-compressed, which can lead to increased friction, premature wear, and potential failure of the seals. The spacer elements help maintain the appropriate compression level for optimal sealing performance. Still further, the spacer elements provide additional support and help prevent extrusion of the primary sealing elements 62, 82 under high pressures and ensuring that the bi-directional sealing assembly 50 maintains an effectiveness seal over time. The spacers can be made of PTFE compounds and/or engineered plastics.

The bi-directional sealing assembly 50 also includes an optional retention element 130, such as a snap ring, that can be coupled to the housing 12 and helps retain and secure the components of the bi-directional sealing assembly 50 in place in the housing 12. Specifically, the retention element 130 helps prevent the components from axially shifting or becoming dislodged due to the reciprocating motion of the plunger rod 40 and the pressure forces within the pump housing 28. The retention element 130 also helps maintain the necessary compression on the bi-directional sealing assembly 50 to ensure that the components of the sealing assembly are tight enough to prevent leaks while allowing the pony rod 40 to move freely therealong and therethrough. The retention element 130 can be configured to lock the entire bi-directional sealing assembly 50 within the housing 12 (e.g., the gland or the stuffing box) to maintain the structural integrity of the seal under various operating conditions, such as high pressure or excessive vibrations. The retention element 130 can be positioned within a groove formed in the housing 12. Once installed, the retention element holds the sealing components securely in place, preventing axial movement of the components along the pony rod 40.

In operation, the bi-directional sealing assembly 50 is mounted within the stationary housing 12 and about the pony rod 40. When mounted therein the flange element 72 of the primary sealing element 62 of the first sealing subassembly 60 is oriented in a first axial direction to provide enhanced sealing in the first direction. The flange element 92 of the primary sealing element 82 of the second sealing subassembly 80 is oriented in a second axial direction opposite the first axial direction to provide enhanced sealing in the second direction. The primary sealing elements 62, 82 are axially spaced apart and are separated by the lantern ring 100.

During pump operation, the plunger 22 reciprocates and the pony rod 40 moves in and out of the pump chamber 28. The pony rod 40 moves through (e.g., back and forth) the bi-directional sealing assembly 50. The bi-directional sealing assembly 50 forms a tight fluid seal around the pony rod 40, preventing oil or other fluids from leaking out of the crankcase housing portion 42 and into the high-pressure pumping side (e.g., pump chamber 28) of the plunger pump 10. The bi-directional sealing assembly 50 mounted within the stationary housing 12 employs first and second sealing subassemblies disposed at opposite sides of the lantern ring 100 to form a bi-directional seal. The bi-directional seal helps prevent fluid and environment contaminants from leaking or passing into the crankshaft side of the plunger pump 10 during movement of the pony rod 40 in both directions. Specifically, when the pony rod 40 is moved laterally during the intake stroke, the sealing subassembly 60 provides a fluid seal with the pony rod 40 and when the pony rod moves during the discharge stroke, the sealing subassembly 80 provides a fluid seal with the pony rod 40. The sealing subassembly 60 employs a primary sealing element 62 that has a bottom surface 64B that has a protruding flange element 72. The flange element 72 is biased into sealing contact with the pony rod 40 by the biasing element 150. The flange element 72 is oriented in the first sealing subassembly to exert a sealing force in a first direction when the pony rod moves in the first direction, such as during the intake stroke. The sealing subassembly 80 employs a primary sealing element 82 that has a bottom surface 84B that has a protruding flange element 92. The flange element 92 is biased into sealing contact with the pony rod 40 by the biasing element 152. The flange element 92 is oriented in the second sealing subassembly to exert a sealing force in a second directional, opposite the first directional, when the pony rod 40 moves in an opposite direction, such as during the discharge stroke. When positioned and oriented as such, the side channels 70, 90 formed in the first and second primary sealing elements 62, 82, respectively face away from each other in opposite directions. This configuration orients the corresponding flange elements 72, 92 in opposite directions to form a sealing assembly that provides bi-directional sealing, at axially spaced apart locations, during movement of the pony rod.

The bi-directional sealing assembly 50 has a bi-directional configuration that serves to maintain lubricants in the crankshaft housing portion 42 and prevents environmental contaminants from entering the crankcase. The lantern ring 100 can be employed to allow passage of a lubricating fluid to lubricate the pony rod, which is not available in conventional pony rod seals. The illustrated lantern ring 100 can have any selected shape and size provided that the lantern ring is used to separate the first and second sealing subassemblies and employ fluid openings that allow for the passage of a cooling or lubricating fluid. The lantern ring can also be used to center and position the first and second sealing subassemblies. According to one embodiment, the retention element 130 can have any selected shape and size. The retention element 130 can be easily installed in the housing 12, and the user does not need to press in seal elements as with conventional pony rod seals. Further, the compression ring can place a small amount of compression on the first and second sealing subassemblies and the lantern ring to prevent seal movement and assist in forming a static seal relative to the rod and housing. Still further, the bi-directional sealing assembly 50 employs the first and second sealing subassemblies to implement bi-directional sealing. The bi-directional sealing assembly 50 also provides a selected amount of allowance for pony rod runout. The biasing elements also allow for uniform wear of the primary sealing elements from the application of a relatively constant spring force. According to the present invention, the second sealing subassembly 80 faces the crankcase and prevents fluid entering the pump chamber 28 from entering the crankcase, and the first sealing subassembly is oriented and positioned to prevent contaminants from entering the crankcase. Further, the flange elements 72, 92 also providing a wiping or scraping action on the pony rod 40 to clean the rod of contaminants.

It will thus be seen that the invention efficiently attains the objects set forth above, among those made apparent from the preceding description. Since certain changes may be made in the above constructions without departing from the scope of the invention, it is intended that all matter contained in the above description or shown in the accompanying drawings be interpreted as illustrative and not in a limiting sense.

It is also to be understood that the following claims are to cover all generic and specific features of the invention described herein, and all statements of the scope of the invention which, as a matter of language, might be said to fall therebetween.

Having described the invention, what is claimed as new and desired to be secured by Letters Patent is:

We claim:

1. A bi-directional sealing assembly for providing a fluid seal for a pony rod in stationary equipment, comprising
a first sealing subassembly having
a first primary sealing element having a main body, wherein the main body has a top surface, an opposed bottom surface, and a side surface having a first side channel formed therein, and
a first biasing element sized and configured for seating in the first side channel, a second sealing subassembly having
a second primary sealing element having a main body, wherein the main body has a top surface, an opposed bottom surface, and a side surface having a second side channel formed therein, and
a second biasing element sized and configured for seating in the second side channel, and
an intermediate mechanical component disposed between the first sealing subassembly and the second sealing subassembly to help position the first and second sealing subassemblies relative to each other,
wherein the first sealing subassembly, the second sealing subassembly, and the intermediate mechanical component are configured to be axially spaced and aligned and concentrically disposed about the pony rod when mounted thereabout.

2. The sealing assembly of claim 1, wherein the top surface of the first primary sealing element has a first top channel formed therein, and wherein the first sealing subassembly further includes a first sealing element sized and configured for seating in the first top channel, and wherein the top surface of the second primary sealing element has a second top channel formed therein, and wherein the second sealing subassembly further includes a second sealing element sized and configured for seating in the second top channel.

3. The sealing assembly of claim 2, wherein the bottom surface of the first primary sealing element has a first flange portion, and the bottom surface of the second primary sealing element has a second flange portion.

4. The sealing assembly of claim 3, wherein the first biasing element when mounted in the first side channel biases the first flange portion outwardly from the bottom surface of the first primary sealing element, and wherein the second biasing element when mounted in the second side channel biases the second flange portion outwardly from the bottom surface of the second primary sealing element, and wherein the first and second flange portions are configured to contact and form a bi-directional fluid seal with the pony rod when mounted thereabout.

5. The sealing assembly of claim 4, wherein the first flange portion extends axially outwardly from the bottom surface of the first primary sealing element in a first axial direction and the second flange portion extends axially outwardly from the bottom surface of the second primary sealing element in a second axial direction opposite to the first axial direction.

6. The sealing assembly of claim 5, wherein the first sealing subassembly forms a first fluid seal when the pony rod moves in a first axial direction, and the second sealing subassembly forms a second fluid seal when the pony rod moves in a second axial direction opposite to the first axial direction.

7. The sealing assembly of claim 6, wherein the intermediate mechanical component directly contacts both of the first sealing subassembly and the second sealing subassembly.

8. The sealing assembly of claim 7, wherein the first primary sealing element has a second side surface opposite the side surface with the first side channel and the second primary sealing element has a second side surface opposite the side surface with the second side channel, and wherein the intermediate mechanical component contacts the second side surface of each of the first primary sealing element and the second primary sealing element.

9. The sealing assembly of claim 6, further comprising one or more spacer elements for axially spacing the first sealing subassembly, the second sealing subassembly, and the intermediate mechanical component along the pony rod.

10. The sealing assembly of claim 9, further comprising a retention element for retaining together the first sealing subassembly, the second sealing subassembly, and the intermediate mechanical component.

11. The sealing assembly of claim 10, wherein the retention element is a snap ring.

12. The sealing assembly of claim 10, wherein the intermediate mechanical component is a lantern ring.

13. The sealing assembly of claim 12, wherein the lantern ring has a plurality of fluid openings formed therein for allowing passage of a fluid therethrough.

14. The sealing assembly of claim 6, wherein each of the first and second biasing elements includes a spring.
